(19) United States
(12) Patent Application Publication
(10) Pub. No.: US 2015/0066933 A1
(43) Pub. Date: Mar. 5, 2015

(54) COMPUTER-IMPLEMENTED METHODS AND SYSTEMS FOR GENERATING VISUAL REPRESENTATIONS OF COMPLEX AND VOLUMINOUS MARKETING AND SALES AND OTHER DATA

(71) Applicant: STRING ENTERPRISES, INC., Newton, MA (US)

(72) Inventors: Kenneth C. Kolodziej, Groton, MA (US); Jason A. Williams, Natick, MA (US)

(73) Assignee: STRING ENTERPRISES, INC., Newton, MA (US)

(21) Appl. No.: 14/476,254

(22) Filed: Sep. 3, 2014

Related U.S. Application Data
(60) Provisional application No. 61/872,917, filed on Sep. 3, 2013.

(51) Int. Cl. G06F 17/30

(52) U.S. Cl. CPC G06F 17/30651; G06F 17/30643; G06F 17/30705; G06F 17/30587
USPC 707/737

(57) ABSTRACT

Computer-implemented visualization techniques are disclosed for transforming data into graphical objects that can be viewed by a user on an electronic display. The visualization techniques enable users to more easily and quickly understand the data, which can be complex and voluminous. The data may include, but is not limited to, marketing and sales data.

### RELATED APPLICATION

This application claims priority from U.S. Provisional Patent Application No. 61/872,917 filed on Sep. 3, 2013 entitled COMPUTER-IMPLEMENTED METHODS AND SYSTEMS FOR CREATING VISUAL REPRESENTATIONS OF MARKETING AND SALES DATA, which is hereby incorporated by reference.

### BACKGROUND

The present application relates generally to computer-implemented methods and systems for generating visual representations of data such as, e.g., marketing and sales data.

### BRIEF SUMMARY

In accordance with one or more embodiments, a computer-implemented method is provided for generating a visual representation of data. The method includes the steps of: (a) receiving the data; (b) organizing the data into a hierarchical order comprising a category and a plurality of subcategories; (c) generating a chart to be displayed on an electronic display, said chart containing a plurality of graphical objects representing the data, said graphical objects including a first tier graphical object representing the category and having a given area, said graphical objects also including a plurality of second tier graphical objects associated with the first tier graphical object, each second tier graphical object representing one of the subcategories of the category and having an area corresponding to the proportion of the subcategory within the category; and (d) transmitting the chart to a computer device operated by a user to be displayed on an electronic display.

A computer system is also provided in accordance with one or more embodiments. The system includes at least one processor, memory associated with the at least one processor, and a program supported in the memory for generating a visual representation of data. The program contains a plurality of instructions which, when executed by the at least one processor, cause the at least one processor to: (a) receive the data; (b) organize the data into a hierarchical order comprising a category and a plurality of subcategories; (c) generate a chart to be displayed on an electronic display, said chart containing a plurality of graphical objects representing the data, said graphical objects including a first tier graphical object representing the category and having a given area, said graphical objects also including a plurality of second tier graphical objects associated with the first tier graphical object, each second tier graphical object representing one of the subcategories of the category and having an area corresponding to the proportion of the subcategory within the category; and (d) transmit the chart to a computer device operated by a user to be displayed on an electronic display.

### BRIEF DESCRIPTION OF THE DRAWINGS

FIG. 1 is a schematic diagram illustrating an exemplary network in which a data visualization system in accordance with one or more embodiments may be implemented.

FIGS. 2A-2G are screenshots illustrating exemplary visual representations of sales and marketing data for a car dealership in accordance with one or more embodiments.

FIGS. 3A and 3B are screenshots illustrating exemplary visual representations of the sales and marketing data by dollar value rather than the number of visitors in accordance with one or more embodiments.

FIGS. 4-7 are screenshots illustrating an exemplary process of generating bubble charts in accordance with one or more embodiments.

### DETAILED DESCRIPTION

Various embodiments disclosed herein are directed to computer-implemented visualization techniques for presenting data including, but not limited to, marketing and sales data. Visualization refers to the transformation of data into graphical objects that can be viewed by a user on an electronic display. Visualization enables users to more easily and quickly understand data that is typically complex and voluminous.

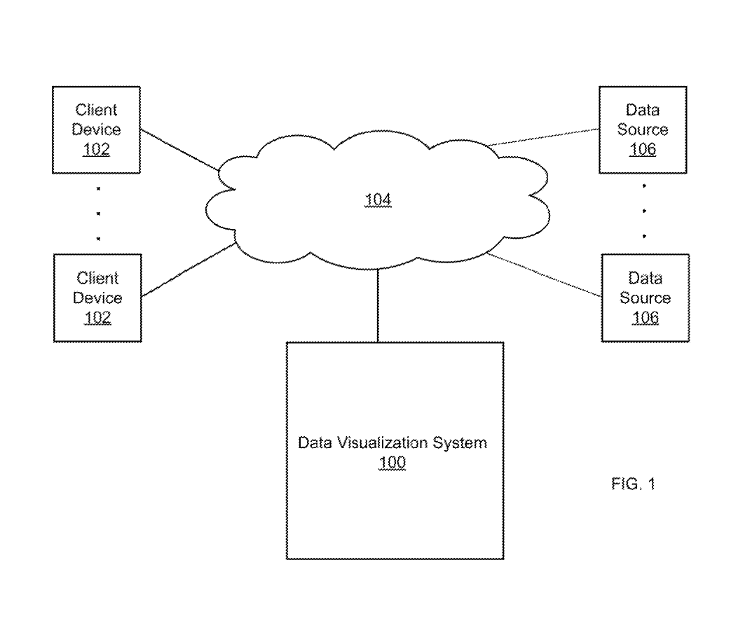

FIG. 1 illustrates an exemplary network, in which a data visualization system 100 in accordance with one or more embodiments may be implemented. The data visualization system 100 is preferably implemented in a computer server system, which communicates with a plurality of client devices 102 operated by the users of the system. The client devices 102 communicate with the system 100 over a communications network 104, which may comprise any network or combination of networks including, without limitation, the Internet, a local area network, a wide area network, a wireless network, and a cellular network. In accordance with one or more embodiments, the data visualization system 100 has a web-based software-as-a-service implementation.

The client devices 102 operated by users to access the visualization system 100 can comprise any computing device that can communicate with the computer server system over the network 104 including, without limitation, personal computers (including desktop, notebook, and tablet computers), smart phones, and cell phones. The data visualization system 100 receives raw data for generating the visual representations from various data sources 106, as will be discussed below.

A representative client device 102 includes at least one computer processor and a storage medium readable by the processor for storing applications and data. The client device also includes input/output devices, including an electronic display for visual output, e.g., an LCD or LED display, which may optionally have touch screen input capabilities.

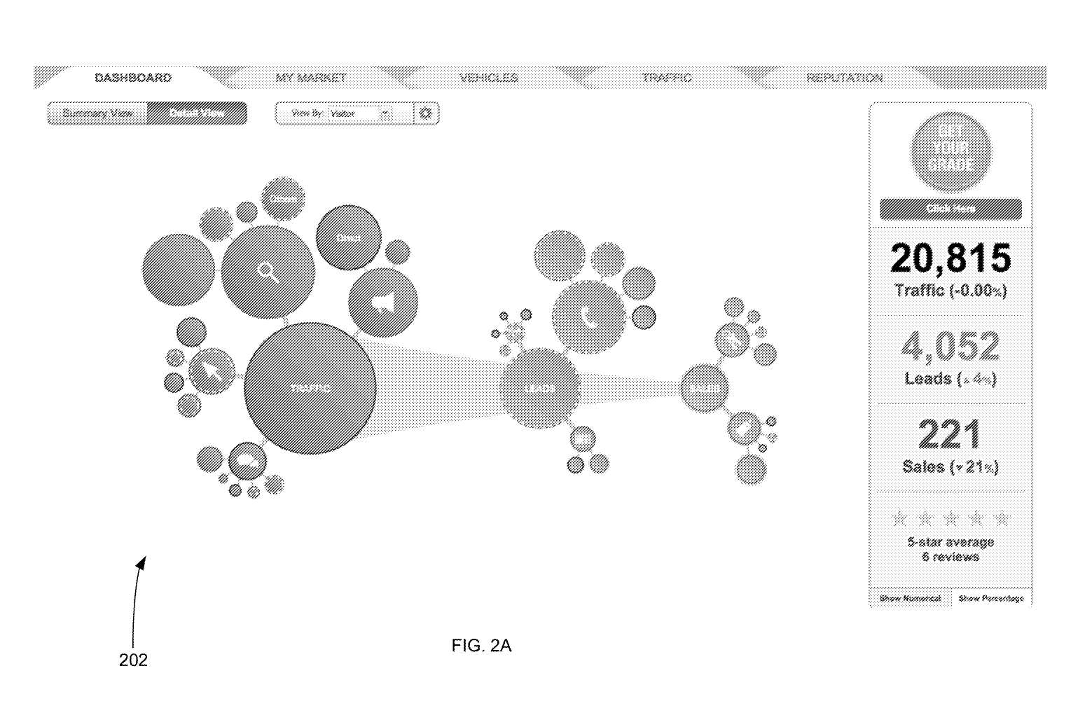

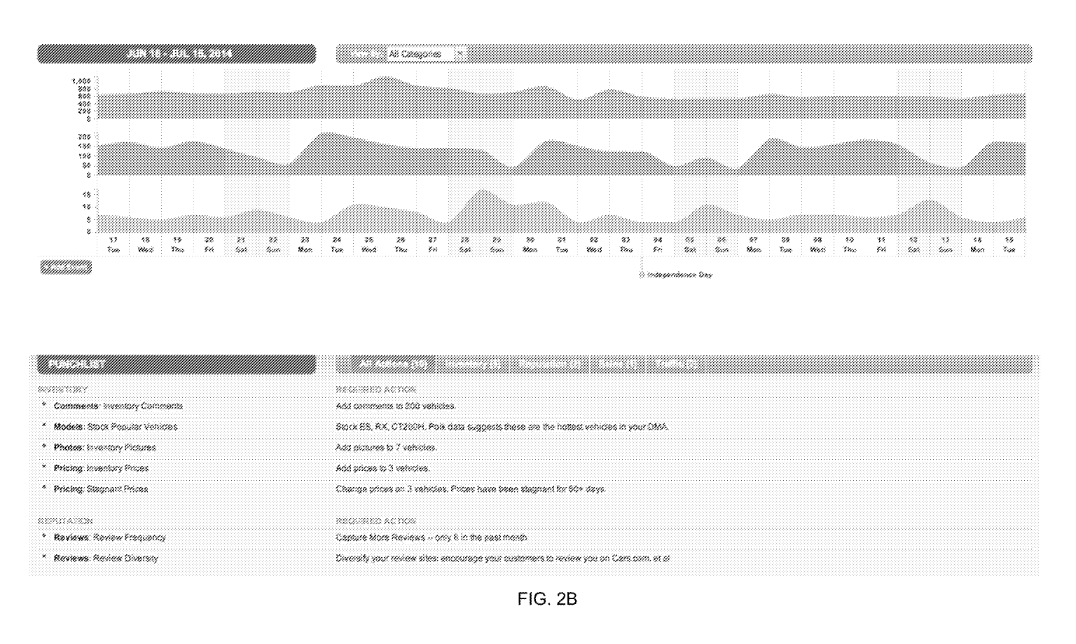

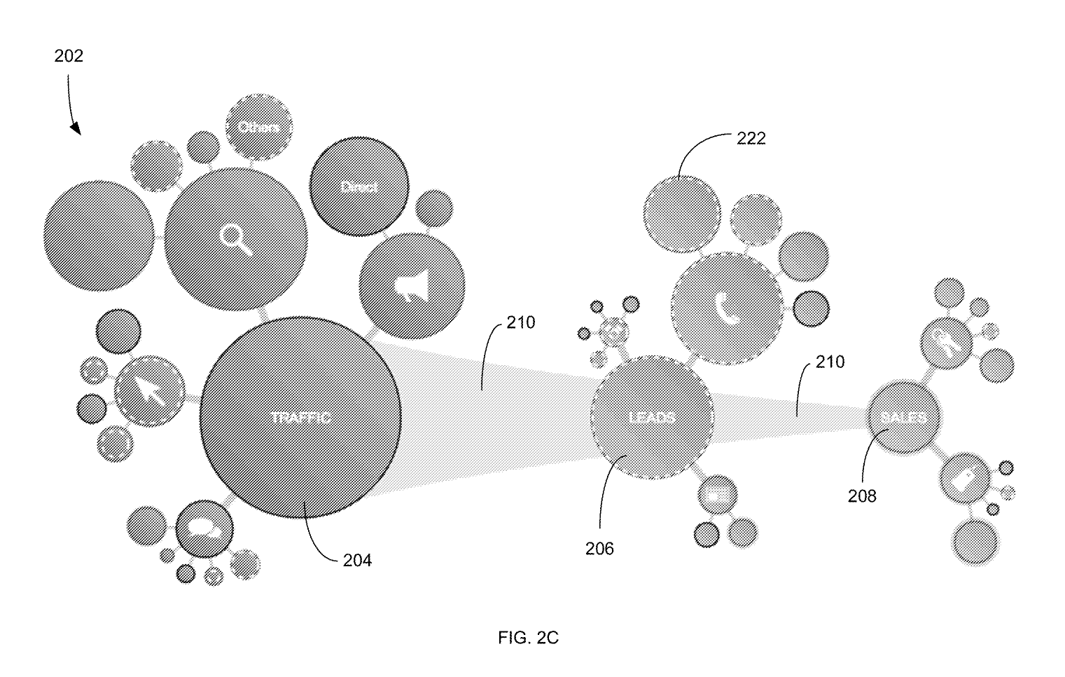

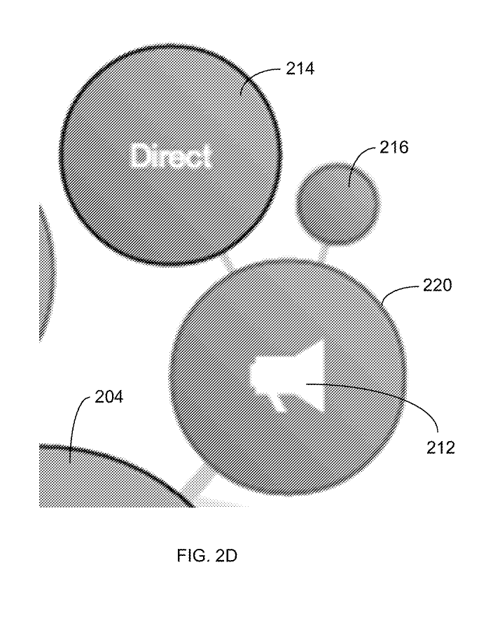

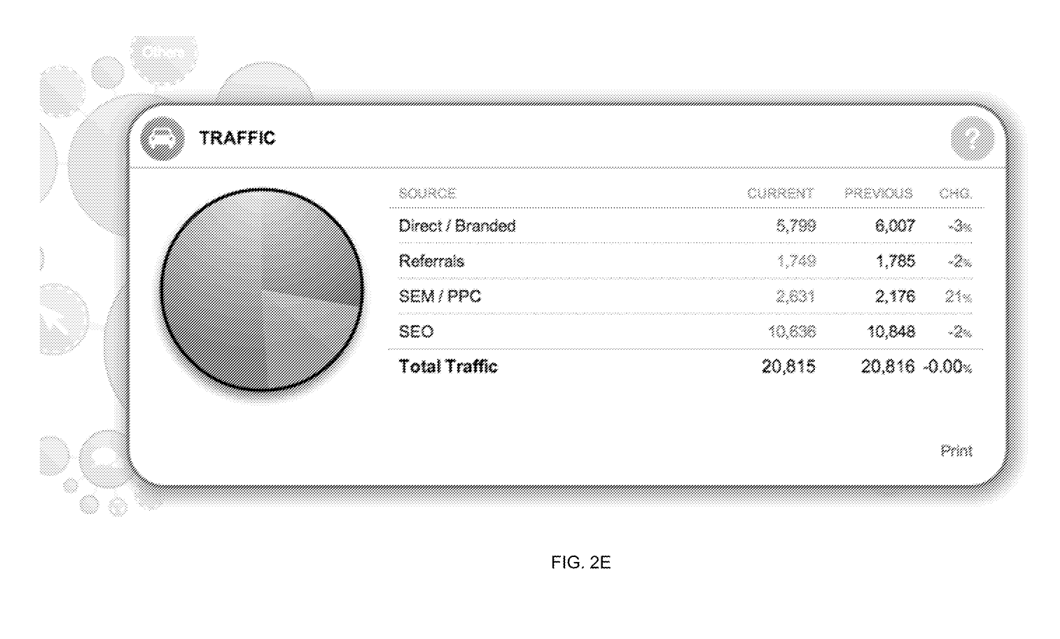

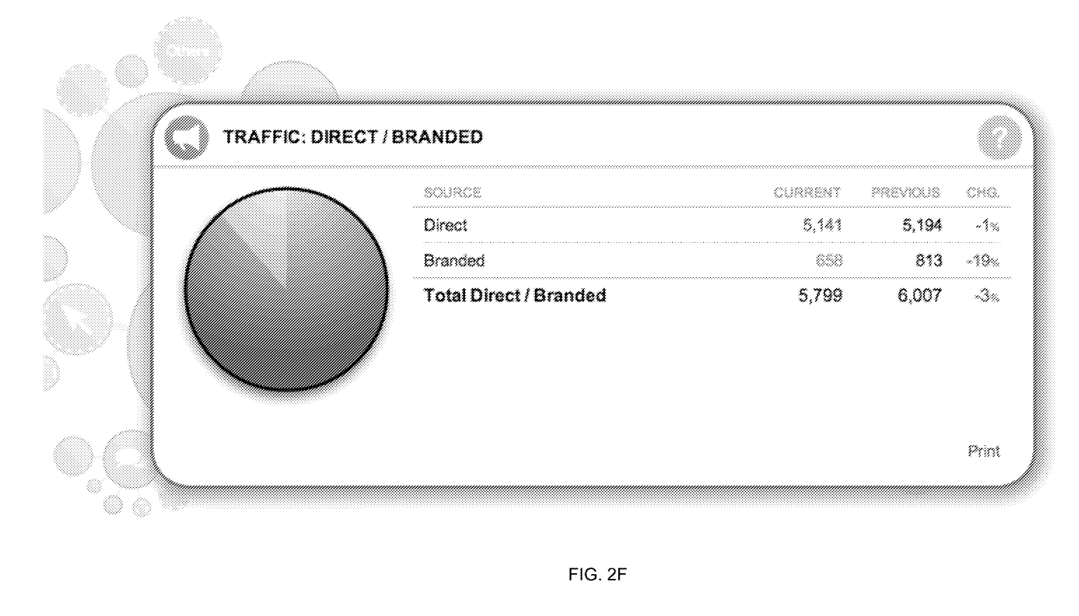

FIGS. 2A-2G are screenshots illustrating exemplary data visualization techniques in accordance with one or more embodiments. In the illustrated examples, the visual representations are for sales and marketing data for an automobile dealership. However, it should be understood that this is for illustrative purposes only. The techniques disclosed herein can be applied to a wide variety of data and industries, and are not limited to the examples illustrated in the screenshots.

FIGS. 2A and 2B are screenshots of an exemplary dashboard presented to an automobile dealership user on a display of a client device 102. The dashboard provides the user with strategic insight into their operations, marketing/advertising spend, local market, and competition. FIGS. 2A and 2B show the top and bottom portions, respectively, of the dashboard.

The dashboard includes an exemplary “bubble chart” 202 shown in greater detail in FIG. 2C. The bubble chart 202 provides the user with an at-a-glance overview of the business's traffic-lead-sales flow, represented by three circles or disks 204, 206, and 208 aligned horizontally from left to right, respectively, joined by a “funnel”-like connector 210.

The traffic circle 204 represents the total amount of website traffic (i.e., the total number of “visitors” to the website of the automobile dealer) during a selected time period.

The leads circle 206 represents the total number of leads to the business during the same time period. A “lead” is defined as any sort of relevant conversion event, possibly—but not exclusively—originating from traffic (as defined above). For a car dealership, a lead could encompass phone calls, website form submissions, website chat sessions, and so forth.

The sales circle 208 represents the total number of sales by the business during the same time period. In the case of a car dealership, this could include both new and used car sales.

Each of the three primary traffic/lead/sales “parent” circles 204, 206, 208 contains one or more “children” connected to the parent by a line. These children represent a specific category of traffic. For example, as shown in FIG. 2D, which is an enlarged view of a portion of the bubble chart of FIG. 2C, a “megaphone” icon 212 represents direct and branded traffic to the website. Direct traffic 214 includes visitors coming to the dealership website without having first visited another website (e.g., visitors opening a new browser tab or window and typing in a web address). Branded traffic 216 includes organic search visitors (e.g., visitors to the website originating from a search engine) who have performed a search on a business-related key phrase. For example, for a car dealership called “Family Motors,” a visitor may search for “family motors” (or some direct derivation) on a Google or other search site, and then click through to the website for Family Motors. Although this visitor is technically an organic search visitor, it may be defined as a “branded search” visitor and added into the overall direct/branded category.

Populating the bubble chart involves first sourcing the data (from one or more data sources 106) that will serve as inputs to the data categories and circles. Raw traffic data can be obtained, e.g., from the Google Analytics API. Raw website lead data can also be obtained from the Google Analytics API. Raw phone tracking data can be obtained from a phone tracking provider's API such as CallSource. Sales data can be obtained from a business's own internal ERP (Enterprise Resource Planning) system. In accordance with one or more embodiments, a combination of real-time and near-real-time data sources can be used through an extensible architecture.

Once the raw data for each category is obtained, it is then stored in a local database for further processing and indexed on certain metrics/columns, such as timestamp, client ID, and so forth. This raw data is refreshed either on-demand or on a daily basis during scheduled batch processing.

Before the data is queried from the local data store to be presented in the bubble chart, it is run through filters to re-categorize appropriately. As discussed above, branded search traffic is extracted from the web traffic data store based on a per-website/per-client configurable list of keywords and terms, which is defined and entered through a separate management interface during account setup. This list is editable in real time, at any time, by authorized administrators. Once the list is defined and/or edited, the data extraction query is re-run, and the bubble chart is refreshed.

Data for all traffic, leads, and sales categories is queried in a similar fashion to the branded search traffic, e.g., it can be extracted from a local data store based on a client ID, a timeframe, and a pre-defined set of parameters that define the specific categories.

Sub-categories are queried depending on the parent category. For example, organic search traffic is extracted by the top three search key phrases by visitor volume, with the balance of key phrases aggregated as “Others.”

The data extraction process is flexible enough to use different metrics and formulae to query for an arbitrary—and near-infinite—set of categories and sub-categories.

In accordance with one or more embodiments, to display the data in the bubble chart, the server returns a data object that contains summary data for traffic, leads, and sales, as well as hierarchical data for each sub-category or “child,” as well as for the children of child categories. Data is returned for both the currently-selected time period as well as for the previous time period, which is for an equivalent length of time (e.g., a time period representing the 30 days prior to present day would be compared to a 30-day time period beginning 60 days prior to present day).

Parent circles (traffic/leads/sales) are placed in fixed positions in the center of the chart, from left to right. The circles are sized first according to the previous period's quantities as a benchmark. The circles are then expanded or contracted accordingly, and the delta is represented by either a red circle/glow 220 (to represent negative growth period-on-period) or by a green circle/glow 222 with dashed white line (to represent positive growth period-on-period). This allows the user to see, at a glance, which categories are growing and which are contracting. The same green/red growth-visualization technique can be used for every circle and category in the chart to allow for the same at-a-glance interpretation.

To create the child circles, each traffic sub-category is added in a fixed position, beginning at the top-right of the traffic circle and continuing counter-clockwise, with enough spacing to allow for subsequent children/bubbles to be displayed. Direct/branded traffic, organic search, paid advertising traffic, and referral sub-categories are all displayed and sized according to their quantity, such that the sum of the areas of all child circles is equivalent to the area of the parent. This geometric relationship holds for each child-parent level relationship.

Children of sub-categories are then displayed using the same top-right start position/counter-clockwise rotation and sizing rules as shown in FIG. 2C.

In accordance with one or more embodiments, upon clicking on any top-level or second-level circle in the bubble chart, a “floating” image is displayed that shows contextual details about the circle that was clicked, based on the data set that was returned from the server during the initial data extraction server response. FIG. 2E shows an example of a detail display for the parent traffic circle, showing a graphical (pie chart) and numeric (raw number) representation of the children of the traffic circle, as well as period-on-period actual numbers and percentage change. FIGS. 2F and 2G detail information for second-level child circles: direct/branded traffic and referral traffic, respectively.

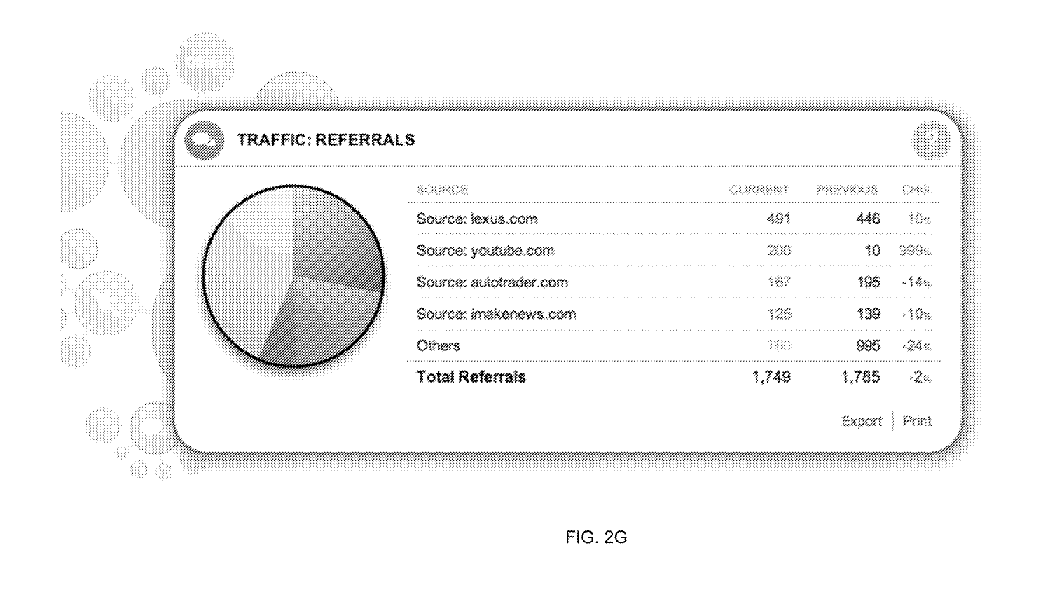

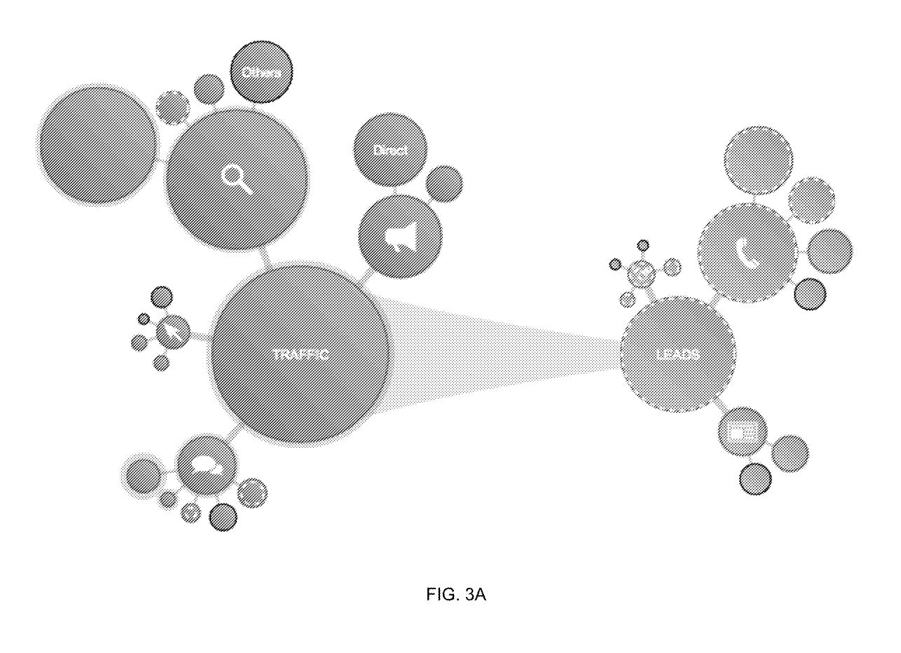

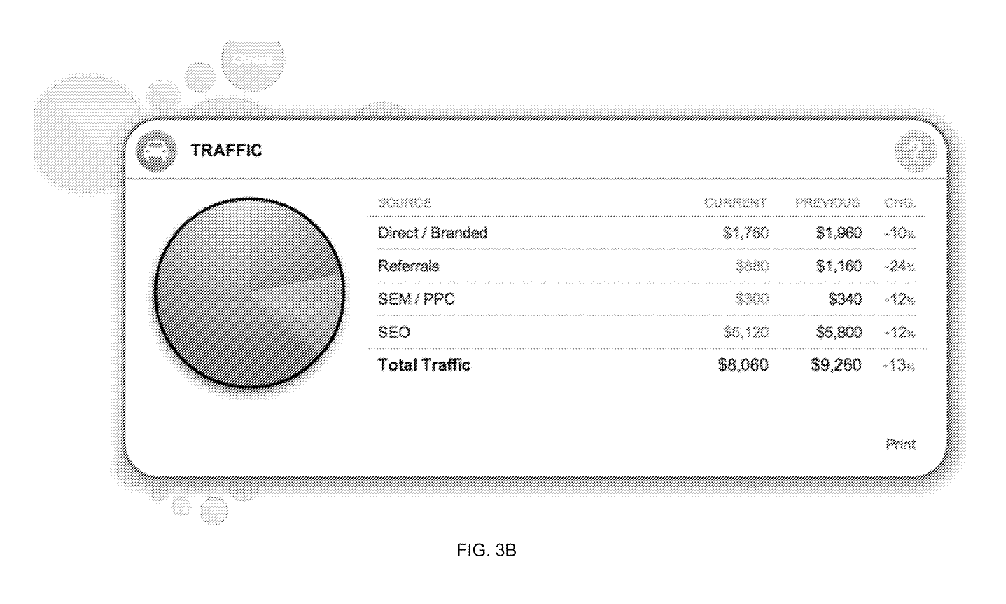

In accordance with one or more embodiments, the bubble charts have a modular nature. By way of example, FIG. 3A re-visualizes the bubble chart of FIG. 2A by dollar value per traffic source, rather than by number of website visitors by source. The system allows the user to ascribe an arbitrary dollar value per lead type. By associating a dollar value to a lead, a lead to a website visitor, and a visitor to a traffic source, the system is able to determine what the total dollar value is for a traffic source. Once this figure is determined, the system alters the display of the traffic, lead, and sales bubbles to show the user an alternate aspect of the data, with an ability to easily toggle between visitor and value views. FIG. 3B shows a breakdown of the dollar values and period-on-period changes described in FIG. 3A, by traffic category.

A more detailed description is now provided on exemplary techniques for generating bubble charts in accordance with one or more embodiments.

As discussed above, the bubble charts allow a user to see and compare the make-up of categorized data along two separate visual lines. First, the bubble chart acts as an “exploded view” of multiple levels, allowing the user to see the proportional composition of a hierarchical set of data. Each level or tier, expanding out from the center, contains a slightly more granular reporting of the same data—the aggregate totals at each tier should be the same. This picture is also overlaid upon the same subset of information for some previous period in time (of equal length), allowing the user to see the growth or decline of those data values. Any data that can be divided up into a hierarchical order and separated into distinct and equal time periods can be displayed in this fashion. Exemplary techniques for generating bubble charts are described below.

For this example, consider tracking the meals for a dieter over the course of 2 days. The data collected might be as follows:
Day 2:
   Breakfast: Eggs and Bacon, Toast and Orange Juice
   Lunch: Chicken Caesar Salad with Apples & Peanut Butter
   Dinner: Steak, Potatoes, and Side Salad
Day 1:
   Breakfast: Ham, Egg and Cheese on English Muffin and ½ Grapefruit
   Lunch: Tuna Salad on Wheat w/Cottage Cheese
   Dinner: Stuffed Peppers (ground beef) with Rice

As a strict hierarchy, this data could be broken down by meal—and for each meal, by “Food Group.” At each entry, the total calories for the two periods are also stored:

/Breakfast: (today: 470, yesterday: 360)
| --- Proteins: (today: 280, yesterday: 200)
| --- Fruit/Veg: (today: 40, yesterday: 60)
| --- Grains: (today: 150, yesterday: 100)

After the totals for Lunch and Dinner are aggregated a “root” level can be added giving the total caloric value for the current period (today) and the prior period (yesterday). This concept could be expanded to track the week-over-week totals for an individual, or even the month-over-month totals for an entire population.

As used herein, a “Node” is an entity comprising a name and set of totals (current period and prior period). “Leaf Nodes” are the outer nodes in the bubble chart—also referred to as “Tier 3 Nodes.” All Leaf Nodes roll up to a single “Parent Node,” which is the aggregate total for a set of Leaf Nodes—also referred to as “Tier 2.” A “Root Node” is the overall total for the displayed class of data—also referred to as the Central Bubble or “Tier 1.” Additional tiers can also be provided, if desired.

“Current Period” refers to a span of time typically from the current date (or moment) back some number of days (or other given time period). “Prior Period” refers to the same span of time as the current period, but offset by one month or year (or other given time period).

The central bubble for the overall total from the “root” node is first created. There are three values used to generate this circle: the node name, the current period total, and the prior period total. The default size for the central bubble is determined using a fixed value—this value will typically be used as the radius for the previous period's circle. Using the percentage change between the previous and current period, a second circle is generated where the area is directly proportional to that change. For example, if the previous period is a circle with a radius of 100 px—and an area of 31,416 (pi*radius squared), and the current period had a value that was 20% greater than the previous period, then the current period would be represented by a circle with a radius of 109.5 px (the square root of (31,416*1.2)). This calculation can be simplified by removing the value of pi from both calculations, and performing the square root operation directly on the percentage change, leaving:

Current Period Radius=Previous Period Radius*Square Root (Percentage Change in Period Totals).

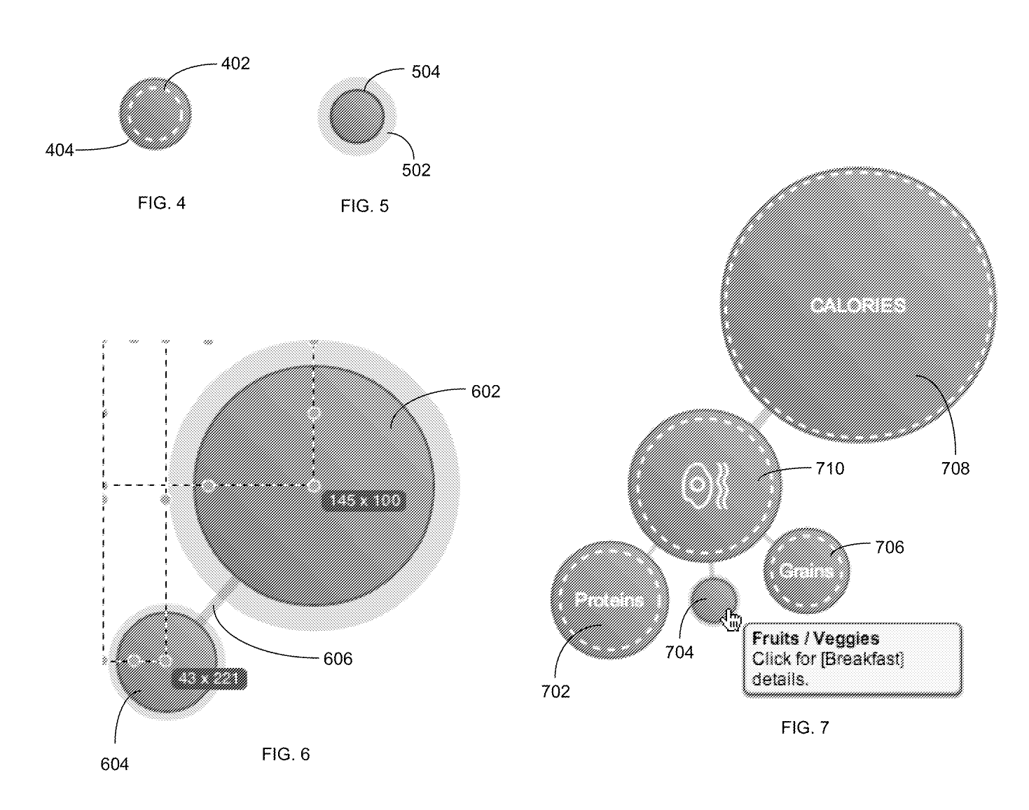

When displaying an increase in totals between periods, the previous period (which will be displayed within the boundaries of the current period) will be represented by a dashed line 402 demarcating the perimeter of that circle as shown in FIG. 4. This will indicate the size of the previous period in relation to the current total. Additionally, the border of the current period circle will be drawn in green at 404 to indicate the positive (increasing) nature of this change.

When the total is decreasing, the change is represented by a semi-transparent “glow” 502 which shows the area of the previous period extending out from behind the current period. This glow and the border of the current period are shaded red at 504 to indicate the negative (decreasing) change between the two periods as shown in FIG. 5.

The two circles should be drawn sequentially to create the correct effect. The larger circle should be drawn first (so that it has the lowest “z-index”) with the smaller circle drawn on top. When the smaller circle is the previous period, this circle should be drawn with a transparent fill, so that only the dashed line is visible. When the two periods have the exact same total, a single circle is drawn with a black border to indicate no period over period change.

Because the next tier of bubbles will be drawn directly proportional to the size of this central circle (the sum of the areas of the next tier should equal the area of this circle), the overall size of the root node bubble should be constrained to prevent the final display (comprising three tiers) from extending beyond the available canvas. So if the increase in totals between the two periods is greater than 125%, the current period bubble size is capped at 112% of the default size (square root of 1.25). To create the correct proportional change between the two periods, the previous period circle (which will be displayed as a broken white line—see FIG. 4) will have its radius decreased from the initial default size down to the correct proportional radius to the current period bubble. For example, if there was a 100% increase in value between the two periods, and the default radius is 100 px, the current period's bubble would be drawn with a green border with a radius of 112 px, and the inner dashed circle would have a radius of slightly more than 79 px. The comparable areas of these two circles would be:

112 (radius)=>39408 (area) vs. 79.2 (radius)=>19706 (area)

Accounting for rounding, the area of the smaller circle is exactly 50% of the current period's. To insure that any bubble displayed is always visible, the minimum diameter for any circle should be set to 10 px.

If the size of the circle rendered is big enough, the node name, or an icon representing the class of data can be displayed within the bubble itself—otherwise an “on hover event/tool tip” is used to display this text.

The second tier is displayed as a set of circles radiating out from the center on “spokes.” These spokes can be defined with the explicit number of degrees at which the spoke should originate, to set an expected order for the display, or lacking this data, the bubbles will be drawn starting at 90 degrees clockwise from the (positive) x-axis. Each subsequent spoke (with an undefined “radial”) will continue to rotate clockwise by 45 degrees.

Each circle at this level represents a portion of the total area of the central bubble; the sum of the total area of all the bubbles displayed at this level will equal the area of the central node. Like the central bubble, the data for each node comprises three values: the name, the current period total, and the prior period total. To calculate the current period radius, the square root of the percentage total (relative to the aggregate sum of this tier) is multiplied by the radius of the central circle for the current period. This circle will not be larger than the center node. For example, if the center node has a radius of 100 px, and the Tier 2 circle being drawn represents 30% of the overall total, the new radius would be 55 px (100*square root of 0.30).

Because the previous period total for this node is available, the prior period can also be drawn as a dashed white line (current period increasing) or a red glow (current period decreasing). The prior period node is calculated using the same square root formula as above, but using the current period radius and the percentage change between the two periods.

To calculate the specific location of the new bubble, its distance from the center node is first determined. This is the sum of the radius of the larger of the two central circles (either to the current period's green border, or the prior period's red outer edge) plus the larger radius of the two current circles along with a buffer value (to create some space between the tiers) of somewhere between 10 and 20 px. The new X and Y coordinates can be calculated as a point on a circle given a center at the root node, a radius of the distance just calculated and an angle determined by the degrees from 0 that the spoke should originate. The function for this calculation given starting coordinates of “a, b”, radius of “r” and rotation angle of “θ” radians is:

(x,y)=(a+r*cos θ, b+r*sin θ)

As shown in FIG. 6, where given an initial circle 602 with an “a, b” coordinate value of (145, 100), a larger radius (showing the prior period with a red glow) of 100 px, a Tier 2 circle 604 with a larger radius of 40 px, a buffer of 18 px, and a radial angle of 130 degrees (clockwise from 0 traveling directly across the x-axis of a grid), the following result (each degree of a circle expressed as a radian angle is 3.14/180, or 0.0174) is obtained:

(x,y)=(145+158*cos(130*0.0174), 100+158*sin(130*0.0174))

(x,y)=(43, 221)

As shown in FIG. 6, to complete the figure, the spoke 606 is drawn as a straight line between the two circles originating at their centers to properly achieve the correct z-index ordering. The spokes should be drawn first, so that they are not visible behind the circles themselves. The process is repeated for each bubble in the Tier 2 set.

The third tier is drawn in the same manner as the second tier, where each child bubble is in exact proportion to the area of the parent that it represents, although aesthetically, it may be necessary to thin out the spoke lines and shorten them slightly to keep them more tightly grouped around their Parent Node. Some reasonable “maximum” of bubbles to appear around the perimeter of the each of these nodes should be defined, or they will overlap. The maximum number of bubbles desired is determined, and the remaining totals can be rolled up into an “Others” node. The radial degrees for the spokes at this level can optionally be defined, although when not present, the first radial will spoke off at 90 degrees (clockwise) from the parent's spoke and increment by 45 degrees for each new node.

The positions for all the bubbles can either be drawn as exact fixed positions, or a “force” algorithm can be employed to help slightly budge the resulting bubbles from their fixed positions to make room for circles that need more space. This is done by recursively making minor changes the x,y positions of bubbles that overlap until none of the bubbles occupy the same space.

Adding in the Leaf Nodes 702, 704, 706 for the Example Data might make the path back to the center bubble 708 look like the image in FIG. 7 (image shown using on hover tool tip for a “small” outer node 704, an icon image at Tier 2 node 710 and a text label for the Root Node 708).

The processes of the visualization system described above may be implemented in software, hardware, firmware, or any combination thereof. The processes are preferably implemented in one or more computer programs executing on a programmable computer (which can be part of the server computer system) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A method, implemented in a computer system, of generating a visual representation of data, comprising the steps of:
(a) receiving the data;
(b) organizing the data into a hierarchical order comprising a category and a plurality of subcategories;
(c) generating a chart to be displayed on an electronic display, said chart containing a plurality of graphical objects representing the data, said graphical objects including a first tier graphical object representing the category and having a given area, said graphical objects also including a plurality of second tier graphical objects associated with the first tier graphical object, each second tier graphical object representing one of the subcategories of the category and having an area corresponding to the proportion of the subcategory within the category; and
(d) transmitting the chart to a computer device operated by a user to be displayed on an electronic display.

2. The method of claim 1, further comprising the step of overlaying the plurality of graphical objects representing the data for a current time period on a corresponding set of graphical objects representing data for a previous time period to enable the user to visualize the growth or decline of data values represented by the graphical objects.

3. The method of claim 2, wherein each graphical object has a disk shape, and when a graphical object representing data for a current time period overlays a graphical object representing data for a previous time period, any delta between the disk shapes is highlighted to assist the user in visualizing the growth or decline of data values represented by the graphical objects.

4. The method of claim 3, wherein the delta is highlighted in green to indicate growth of data values and red to indicate decline of data values.

5. The method of claim 2, wherein each graphical object is disk shaped, and wherein the perimeter of the area of a graphical object representing data for a previous time period is indicated by a dashed line when that graphical object is smaller in size than the graphical object for a current time period.

6. The method of claim 1, wherein the area of the first tier graphical object is equal to the sum of the areas of the corresponding second tier graphical objects.

7. The method of claim 1, further comprising generating third tier graphical objects representing a further subcategory of one or more of the second tier graphical objects.

8. The method of claim 1, wherein each of the second tier graphical objects is connected to the first tier graphical object by a spoke extending radially from the first tier graphical object.

9. The method of claim 1, wherein the chart is configured such that a floating image is displayed when a user clicks on a graphical object, said floating image providing contextual information on the graphical object.

10. The method of claim 1, wherein the chart is modular and the user can toggle between different types of data values.

11. The method of claim 1, wherein the data comprises sales and marketing data.

12. The method of claim 11, wherein the sales and marketing data relate to an automobile dealership.

13. The method of claim 1, wherein step (b) further comprises organizing the data into one or more further categories and corresponding subcategories, and wherein step (c) further comprises generating a plurality of first tier graphical objects, each representing one of the categories and a plurality of second tier graphical objects corresponding to each of the first tier graphical objects.

14. The method of claim 13, wherein the first tier graphical objects include a traffic bubble representing a total amount of traffic to a given website, a leads bubble representing a total number of leads to a given business, and a sales bubble representing a total number of sales by the business.

15. A computer system, comprising:
at least one processor;
memory associated with the at least one processor; and
a program supported in the memory for generating a visual representation of data, the program containing a plurality of instructions which, when executed by the at least one processor, cause the at least one processor to:
(a) receive the data;
(b) organize the data into a hierarchical order comprising a category and a plurality of subcategories;
(c) generate a chart to be displayed on an electronic display, said chart containing a plurality of graphical objects representing the data, said graphical objects including a first tier graphical object representing the category and having a given area, said graphical objects also including a plurality of second tier graphical objects associated with the first tier graphical object, each second tier graphical object representing one of the subcategories of the category and having an area corresponding to the proportion of the subcategory within the category; and
(d) transmit the chart to a computer device operated by a user to be displayed on an electronic display.

16. The system of claim 15, further comprising instructions causing the processor to overlay the plurality of graphical objects representing the data for a current time period on a corresponding set of graphical objects representing data for a previous time period to enable the user to visualize the growth or decline of data values represented by the graphical objects.

17. The system of claim 16, wherein each graphical object has a disk shape, and when a graphical object representing data for a current time period overlays a graphical object representing data for a previous time period, any delta between the disk shapes is highlighted to assist the user in visualizing the growth or decline of data values represented by the graphical objects.

18. The system of claim 17, wherein the delta is highlighted in green to indicate growth of data values and red to indicate decline of data values.

19. The system of claim 16, wherein each graphical object is disk shaped, and wherein the perimeter of the area of a graphical object representing data for a previous time period is indicated by a dashed line when that graphical object is smaller in size than the graphical object for a current time period.

20. The system of claim 15, wherein the area of the first tier graphical object is equal to the sum of the areas of the corresponding second tier graphical objects.

21. The system of claim 15, further comprising instructions causing the processor generating third tier graphical objects representing a further subcategory of one or more of the second tier graphical objects.

22. The system of claim 15, wherein each of the second tier graphical objects is connected to the first tier graphical object by a spoke extending radially from the first tier graphical object.

23. The system of claim 15, wherein the chart is configured such that a floating image is displayed when a user clicks on a graphical object, said floating image providing contextual information on the graphical object.

24. The system of claim 15, wherein the chart is modular and the user can toggle between different types of data values.

25. The system of claim 15, wherein the data comprises sales and marketing data.

26. The system of claim 25, wherein the sales and marketing data relate to an automobile dealership.

27. The system of claim 15, wherein (b) further comprises organizing the data into one or more further categories and corresponding subcategories, and wherein step (c) further comprises generating a plurality of first tier graphical objects, each representing one of the categories and a plurality of second tier graphical objects corresponding to each of the first tier graphical objects.

28. The system of claim 27, wherein the first tier graphical objects include a traffic bubble representing a total amount of traffic to a given website, a leads bubble representing a total number of leads to a given business, and a sales bubble representing a total number of sales by the business.
